(19) United States
(12) Patent Application Publication
(10) Pub. No.: US 2024/0094462 A1
(43) Pub. Date: Mar. 21, 2024

(54) SILICON PHOTONIC MULTIPLEXER AND DE-MULTIPLEXER

(71) Applicant: Avago Technologies International Sales Pte. Limited, Singapore (SG)

(72) Inventors: Shiyun Lin, San Jose, CA (US); Near Margalit, Westlake Village, CA (US); Amit Khanna, Fremont, CA (US)

(21) Appl. No.: 17/946,955

(22) Filed: Sep. 16, 2022

(51) Int. Cl. G02B 6/12; G02B 6/122; G02B 6/125; G02B 6/132; G02F 1/21

(52) U.S. Cl. CPC G02B 6/12007; G02B 6/1228; G02B 6/125; G02B 6/132; G02F 1/212; G02B 2006/12061; G02B 2006/12109; G02B 2006/12147; G02B 2006/12159

(57) ABSTRACT

An integrated circuit including an optical waveguide is described. The optical waveguide includes cascaded Mach-Zehnder interferometers (MZI) filters. The cascaded MZI filters are used for multiplexing and/or demultiplexing. The cascaded MZI filters achieve a desired level of center waveguide accuracy. The center waveguide accuracy may be achieved by any one or more of the following: trimming the MZI filters to a target thickness, interleaving phase sections of the cascaded MZI filters, nonlinear tapers, compact directional couplers, dummification, and/or phase sections with widths selected for phase compensation.

### TECHNICAL FIELD

The present invention generally relates to integrated optical circuits, and more specifically to optical waveguides forming a wavelength division multiplexing by Mach-Zehnder interferometers (MZI).

### BACKGROUND

Wavelength-division multiplexing (WDM) may refer to a concept in communication of using multiple wavelengths on an individual fiber to carry multiple streams of data. WDM may be one component of high-density links in optical communication systems which are limited by the fiber input/output (I/O) density. At the end points of the fiber, the streams of data are combined (e.g., multiplexed) and the streams of data are separated (demultiplexed).

Silicon photonics may be used for high speed, high bandwidth density optical communications. In particular, silicon photonics may be advantageous for optical communication systems due to low power consumption and potential cost savings. Multiplexer/Demultiplexer (Mux/Demux) are components of the optical communication systems which combine and split the optical signals with different wavelengths before and after coupling to fibers. One parameter for the Mux/Demux includes a center wavelength accuracy and consistency of bands that are aligned to the wavelength grid. Another parameter for the Mux/Demux includes a bandwidth of a filter passband that can compensate an input laser wavelengths variation. The bandwidth may be defined by design. However, phase errors may cause degradation. Another parameter for the Mux/Demux includes crosstalk between different wavelengths.

In some instances, fabrication errors and temperature variations may cause center wavelength variation for the Mux and Demux. One or more approaches may be used to control the center wavelength.

One approach to the control center wavelength variations may be to use active tuning. In particular, a heater may be used to tune the temperature of the cascaded Mach-Zehnder interferometers (MZI). For example, the center wavelength may be measured after the cascaded MZI is formed. The heater may then actively control the phase and lock the center wavelength. Using the heaters may increase the total power consumption and is not preferred for applications with large channel counts, due to increased complexity and power.

Another approach to control the center wavelength variations may be to use an off-chip Mux/Demux. The off-chip Mux/Demux may add cost and complexity to the integration. In addition, the off-chip Mux/Demux may be challenging to implement in high-density optical interconnects, such as Co-Packaged Optics (CPO).

Another approach to control the center wavelength variations may be to use passive designs including materials such as Silicon Nitride (SiN) with lower thermo-optical coefficient for lower temperature sensitivity. However, fabrication errors make the use of the passive materials hard to meet a given specification requirement with high yield for large volume production. Therefore, it would be advantageous to provide a device, system, and method that cures the shortcomings of the passive designs described above.

### SUMMARY

A method is disclosed, in accordance with one or more embodiments of the present disclosure. In some embodiments, the method includes depositing a film on a substrate. In some embodiments, the method includes measuring an actual thickness of the film. In some embodiments, the method includes comparing the actual thickness with a target thickness of the film. In some embodiments, the method includes trimming the actual thickness of the film to within a range of the target thickness based on comparison of the actual thickness to the target thickness. In some embodiments, the method includes fabricating an optical waveguide from the film. In some embodiments, the optical waveguide is configured as a wavelength division multiplexer (WDM) for an optical signal by one or more cascaded Mach-Zehnder interferometer (MZI) filters, wherein the trimming affects a center wavelength of the WDM.

An integrated circuit is disclosed, in accordance with one or more embodiments of the present disclosure. In some embodiments, the integrated circuit includes a substrate. In some embodiments, the integrated circuit includes an optical waveguide on the substrate. In some embodiments, the optical waveguide is configured for wavelength division multiplexing (WDM) an optical signal. In some embodiments, the optical waveguide includes a first port. In some embodiments, the optical waveguide includes a first stage. In some embodiments, the first stage includes a first cascaded Mach-Zehnder interferometer (MZI) filter and a first pair of cascaded MZI filters. In some embodiments, the first cascaded MZI filter is coupled to the first port. In some embodiments, the first pair of cascaded MZI filters are each coupled to the first cascaded MZI filter. In some embodiments, the first cascaded MZI filter and the first pair of cascaded MZI filters each include one or more passbands. In some embodiments, the optical waveguide includes a plurality of second ports.

An integrated circuit is disclosed, in accordance with one or more embodiments of the present disclosure. In some embodiments, the integrated circuit includes a substrate. In some embodiments, the integrated circuit includes an optical waveguide formed of a silicon nitride film on the substrate. In some embodiments, the optical waveguide is configured for wavelength division multiplexing (WDM) an optical signal. In some embodiments, the optical waveguide includes a first port. In some embodiments, the optical waveguide includes a first stage including a first cascaded Mach-Zehnder interferometer (MZI) filter and a first pair of cascaded MZI filters. In some embodiments, the first cascaded MZI filter is coupled to the first port. In some embodiments, the first pair of cascaded MZI filters are each coupled to the first cascaded MZI filter. In some embodiments, the optical waveguide includes a second stage. In some embodiments, the second stage includes a second cascaded MZI filter and a second pair of cascaded MZI filters. In some embodiments, the second cascaded MZI filter is coupled to a first of the first pair of cascaded MZI filters. In some embodiments, the second pair of cascaded MZI filters are each coupled to the second cascaded MZI filter. In some embodiments, a first of the second pair of cascaded MZI filters includes a first passband. In some embodiments, a second of the second pair of cascaded MZI filters includes a second passband. In some embodiments, the second stage includes a third cascaded MZI filter and a third pair of cascaded MZI filters. In some embodiments, the third cascaded MZI filter is coupled to a second of the first pair of cascaded MZI filters. In some embodiments, the third pair of cascaded MZI filters are each coupled to the third cascaded MZI filter. In some embodiments, a first of the third pair of cascaded MZI filters includes a third passband. In some embodiments, a second of the third pair of cascaded MZI filters includes a fourth passband. In some embodiments, the optical waveguide includes a plurality of second ports. In some embodiments, the plurality of second ports includes four ports. In some embodiments, the first cascaded MZI filter and the first pair of cascaded MZI filters each comprise fourth-order MZI filters. In some embodiments, the second cascaded MZI filter, the second pair of cascaded MZI filters, the third cascaded MZI filter, and the third pair of cascaded MZI filters each comprise a third-order MZI filters.

### BRIEF DESCRIPTION OF THE DRAWINGS

Implementations of the concepts disclosed herein may be better understood when consideration is given to the following detailed description thereof. Such description makes reference to the included drawings, which are not necessarily to scale, and in which some features may be exaggerated and some features may be omitted or may be represented schematically in the interest of clarity. Like reference numerals in the drawings may represent and refer to the same or similar element, feature, or function. In the drawings:

FIG. 1 depicts a flow diagram of a method for controlling a thickness of a cascaded MZI filter, in accordance with one or more embodiments of the present disclosure.

FIGS. 2A-2B depict a graph of pre-trimming thickness and post-trimming thickness, in accordance with one or more embodiments of the present disclosure.

FIG. 3A depicts a block diagram of an integrated circuit including an optical waveguide, in accordance with one or more embodiments of the present disclosure.

FIG. 3B depicts a transmission spectrum of an optical waveguide, in accordance with one or more embodiments of the present disclosure.

FIGS. 4A-4B depict a schematic diagram of a Mach-Zehnder interferometers (MZI) filter, in accordance with one or more embodiments of the present disclosure.

FIG. 5A depicts a transmission spectrum without phase compensation, in accordance with one or more embodiments of the present disclosure.

FIG. 5B depicts a transmission with phase compensation, in accordance with one or more embodiments of the present disclosure.

FIG. 6A depicts a linear taper, in accordance with one or more embodiments of the present disclosure.

FIG. 6B depicts a nonlinear taper, in accordance with one or more embodiments of the present disclosure.

FIG. 7A depicts a fourth order filter, in accordance with one or more embodiments of the present disclosure.

FIG. 7B depicts a third order filter, in accordance with one or more embodiments of the present disclosure.

FIG. 8A depicts an S-bend coupler, in accordance with one or more embodiments of the present disclosure.

FIG. 8B depicts a α-bend coupler, in accordance with one or more embodiments of the present disclosure.

FIGS. 9A-9C depicts a layout of an exemplary wavelength division multiplexer, in accordance with one or more embodiments of the present disclosure.

FIG. 10 depicts uniform dummification, in accordance with one or more embodiments of the present disclosure.

FIG. 11 depicts a block diagram of an integrated circuit including an optical waveguide with three stages and eight channels, in accordance with one or more embodiments of the present disclosure.

### DETAILED DESCRIPTION OF THE INVENTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details are set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

It is noted herein “coupled” may mean one or more of communicatively coupled, electrically coupled, and/or physically coupled for the purposes of the present disclosure. As used herein, coupled may refer to a direct or indirect coupling. An indirect coupling may refer to a connection via another function element. A direct coupling may refer to a connection without intermediary functional elements. It is noted herein that by being “coupled between”, it may be understood to be relative to movement or flow of a signal between two or more components, and may additionally include intervening components therein.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

Reference will now be made in detail to the subject matter disclosed, which is illustrated in the accompanying drawings.

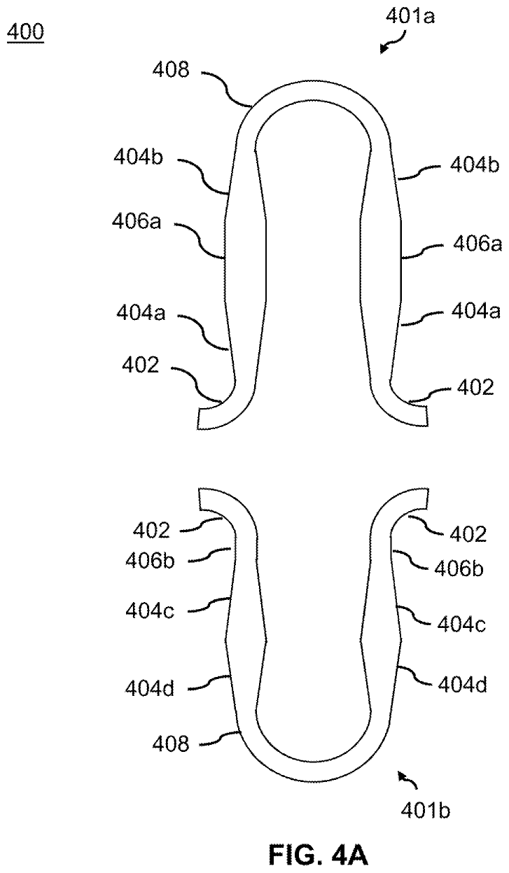

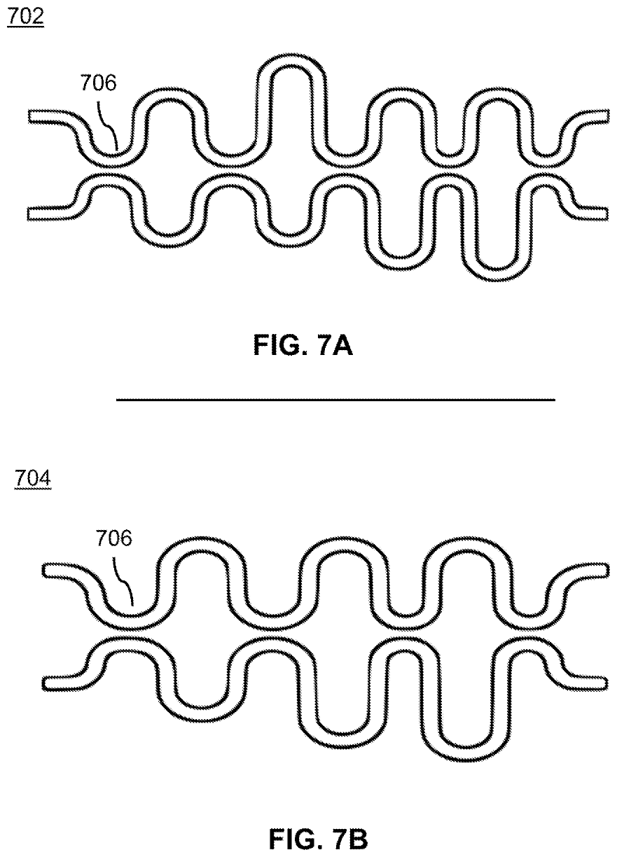

An optical waveguide may be formed of a material that is transmissible to optical signals. The material may guide a wave, such as an optical signal. Optical waveguide may refer to a structure that is designed to confine and direct the propagation of light such that the electromagnetic energy of the one or more guided modes supported by the structure remains substantially confined therein. Of course, as one skilled in the art will readily understand, guided modes generally present an evanescent field that extends partially outside of the waveguide. The material may also be compatible with the use on the wafer in silicon photonics. For example, the material of the optical waveguide may include a film of silicon nitride, or a similar material. The use of silicon nitride may be advantageous for reducing the effects on the center wavelength of the filter due to temperature. The silicon nitride may be used to form a wavelength division multiplexer by the use of cascaded Mach-Zehnder interferometer (MZI) filters. The cascaded MZI filter may be a structure for a wavelength division multiplexer (WDM). An MZI filter may include, but is not limited to, one or more sections which function as a splitter and recombiner for an optical signal. Further discussion of the sections of the MZI filter may be understood with reference to the description of FIGS. 4A-6B. Cascaded may generally refer to a plurality of MZI filters which may be connected in series to form a higher order filter. Thus, cascaded MZI filters may refer to a plurality of MZI filters coupled in series. The order of the cascaded MZI filter may be based on the number of MZI filters cascaded in series, which may be further understood with reference to the description of FIGS. 7A-7B. The cascaded MZI filters may then be joined in one or more stages to achieve separation into multiple channels.

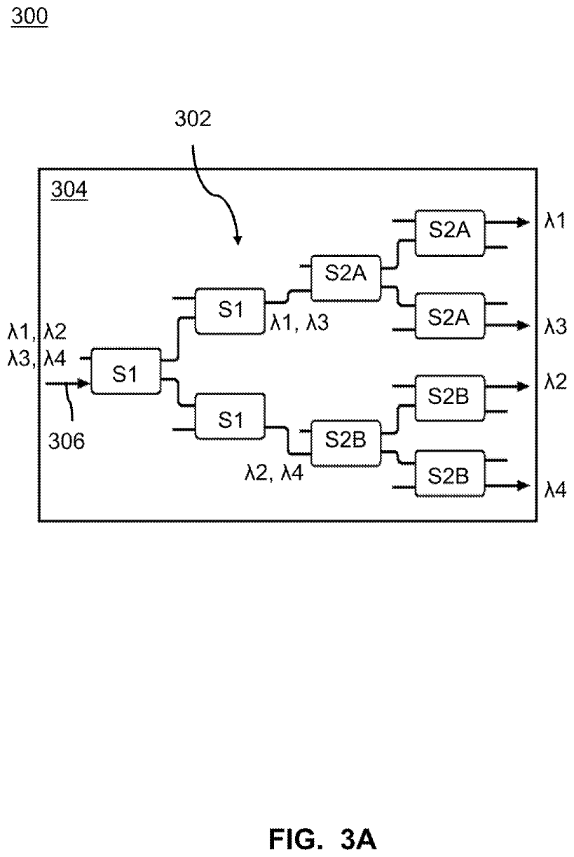

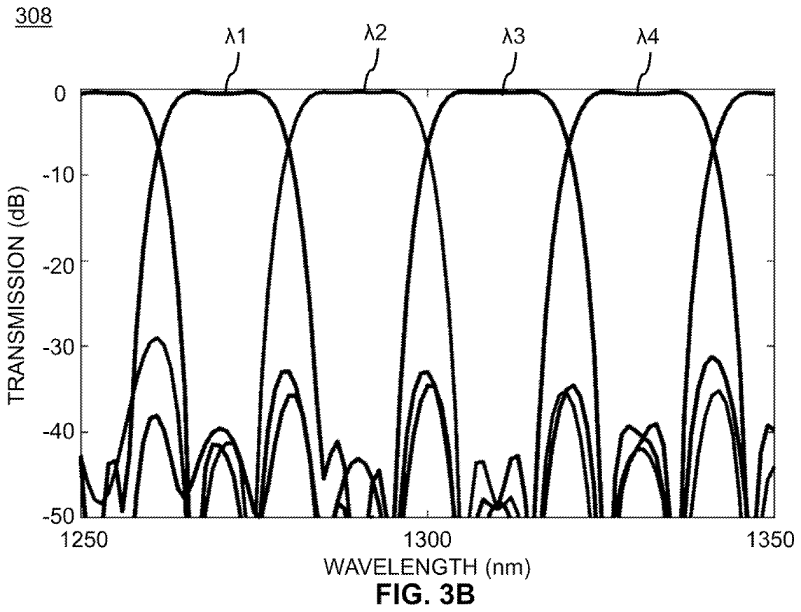

The silicon nitride layer may be well suited to demultiplexing due to a relatively compact package size. Additionally, the silicon nitride layer may be may include a relatively temperature insensitive nature which may be advantageous for demultiplexing. However, the silicon nitride may introduce phase error. The phase error may refer to a phase difference between a reference signal and a measured signal. The phase error may also be referred to as a center wavelength error of a channel. Center wavelength may refer to the wavelength in a center of a channel. As used herein, channel may refer a passband of light. The center of the channel may refer to a frequency disposed in the center between upper and lower cutoff frequencies for the passband, which may be further understood with reference to the description of FIG. 3A. In this regard, center wavelength error may refer to an error between the measured center wavelength of the channel and the expected center wavelength. The phase error may be caused by variation in one or more of the thickness of the film, the width of the waveguide, and the sidewall angle. Sidewall angle may refer to an angle of a sidewall (not depicted) of the silicon nitride (SiN) film. For example, a sidewall angle of 90 degrees may indicate the sidewall is perpendicular to the substrate.

The phase error may accumulate along a light path of the optical waveguide. One challenge with implementing cascaded MZI filters in the silicon nitride film may be that the demultiplexed wavelength is sensitive to the phase errors.

An optical waveguide without active control is described. Wavelength division multiplexing (WDM) may be performed by the optical waveguide. The optical waveguide may be on a chip (e.g., a platform, a silicon photonics chip, etc.), such that the package including the optical waveguide and the chip may be referred to as an on-chip WDM. The chip may receive streams of light and then multiplex and/or demultiplex the streams of light. The on-chip WDM without active control may be based on passive devices. The passive devices may eliminate the need for active tuning. Eliminating the active tuning of the optical waveguide may reduce the cost and power consumption of the active waveguide. Design and process optimization for the passive devices may be performed at the wafer-level and/or have a minimal interruption to standard CMOS processes. Advantageously, the wafer-level optimization may allow for low cost and high-volume production. The passive devices may include any suitable device for performing WDM, such as, but not limited to, cascaded MZI filters.

The optical waveguide may control phase error, in accordance with one or more embodiments of the present disclosure. The phase error may generally be controlled by accommodating for fabrication errors in width, thickness, sidewall angle, and/or refractive index variations. The phase errors may be caused by the fabrication tolerances of waveguide width and sidewall angle variations. In embodiments, the optical waveguide may be designed to phase compensate for the variations. In particular, the cascaded MZI filters may include phase sections with widths and lengths. The widths and lengths may be selected for phase compensation. Phase compensation may include cancelling out index changes on top and bottom arms of the cascaded MZI filter. As used herein, index may refer to the refractive index. The index may be a dimensionless number indicating the ability of light to bend within a medium. Compensating for the phase errors may improve the center wavelength.

The optical waveguide may be formed of a film. Thickness variations in the film may be a significant contributor to center wavelength error (e.g., phase error) of an optical waveguide. Controlling the thickness variations may also improve the center wavelength. The phase error caused by thickness variation may be difficult to compensate for by layout design. In some embodiments, variations in the silicon nitride film layer may be controlled by trimming. For instance, an actual thickness of the material on the wafers may be measured, characterized, and then trimmed to a target thickness. The actual thickness may be trimmed to the target thickness by any suitable process, such as, but not limited to, by an ion beam milling system. Trimming to the target thickness allows for controlling the wavelength of the cascaded MZI to a given tolerance. With the thickness, the silicon nitride films may then be used for multiplexing/demultiplexing purposes in wavelength division multiplexing (WDM), particularly for cascaded Mach-Zehnder interferometers (MZI) filters.

One contributor to changes in the width of the waveguide and the sidewall angle may be process variations. Process variations may be experienced with an increased likelihood as the footprint of the optical waveguide increases. As used herein, footprint may refer to an area (e.g., a width and length) on a substrate occupied by the optical waveguide. In some embodiments, a footprint of the optical waveguide may be designed to have a minimal area. Embodiments of the present disclosure are directed to interleaving phase sections of the cascaded MZI filters, using nonlinear tapers, and/or using compact directional couplers. Any of the interleaving phase sections of the cascaded MZI filters, nonlinear tapers, and/or compact directional couplers may be used to reduce the footprint. Thus, the various embodiments for reducing the footprint may advantageously reduce a likelihood of the optical waveguide experiencing process variations.

Improving the uniformity of the optical waveguide may also improve the center wavelength. In some embodiments, uniform dummification surrounding the optical waveguide may be used. The dummification surrounding the optical waveguide may improve the uniformity of the optical waveguide. Dummification may include silicon nitride dummies, as will be described further herein.

Any of the various embodiments described may be used in combination with any of the other various embodiments described herein. For example, an optical waveguide may include any combination of trimming the MZI filters to a target thickness, interleaving phase sections of the cascaded MZI filters, nonlinear tapers, compact directional couplers, dummification, phase compensation based on width, and the like. In this regard, any the various combinations may be used in combination to improve the center wavelength accuracy of the optical waveguide.

Advantageously, the optical waveguide provides a WDM using a silicon nitride (SiN) film formed or fabricated into a cascaded MZI filter. The silicon nitride film may have a reduced sensitivity to temperature, as compared to a silicon film. The sensitivity may be defined based on a thermo-optic coefficient. The thermo-optic coefficient may indicate a change in refractive index in response to temperature. The reduced sensitivity of the silicon nitride film may allow the optical waveguide to function as a WDM without a heater. Additionally, the optical waveguide may have fabrication errors that may be precisely compensated. The optical waveguide may or may not include a relatively high-order cascaded MZI filters for one or more stages. The relatively high-order cascaded MZI filters may achieve a flattop response. The term flattop response may refer to a passband of a filter with at or near zero decibels of gain in the passband. The flattop response may include a relatively wide bandwidth. The optical waveguide may include repeated stages or stage doubling. The repeated stages/stage doubling may improve crosstalk. Crosstalk may refer to signal leakage between arms of the MZI filter.

In embodiments, the optical waveguide including the cascaded MZI filters may be used in an optical transceiver. The optical waveguide may also be used in a co-packaged optics module. The optical waveguide may provide a wavelength division multiplexing (WDM) optical interconnect for the optical transceiver and/or co-packaged optics module. The co-package optics module may generally refer to an integration of optics and silicon on a single packaged substrate. As used herein, a substrate may also be referred to as a die, wafer, blanket wafer, a silicon wafer, and/or a silicon photonics-based wafer. Such optical transceiver and co-packaged optics module may be useable in any number of optical communication system architectures.

As may be understood, the recitations of multiplexer herein may also be applicable to demultiplexers (and vice versa). The multiplexer may be configured as a demultiplexer by rearranging the ports of the multiplexer. Input ports of the multiplexer may be considered output ports of the demultiplexer. Similarly, output ports of the multiplexer may be considered input ports of the demultiplexer.

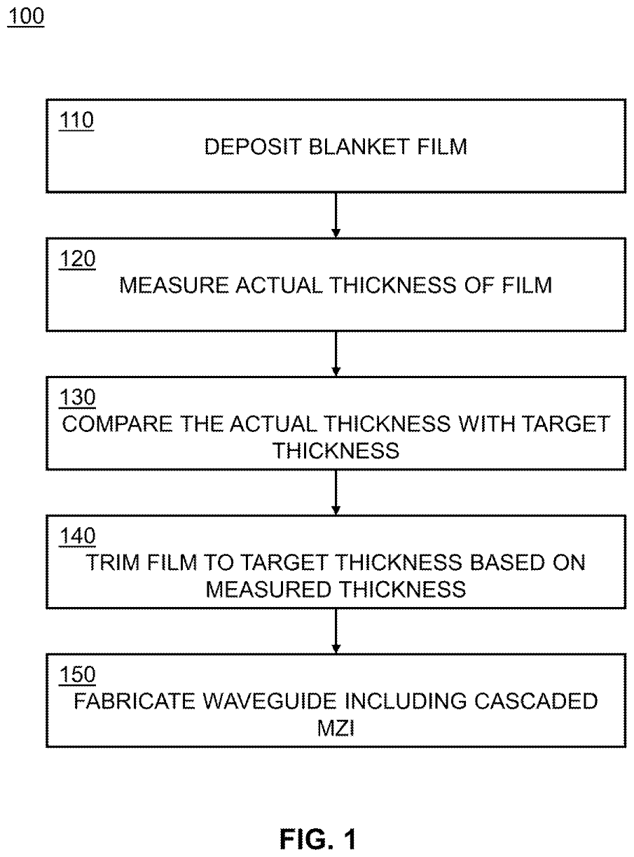

Referring now to FIG. 1, a flow diagram of a method 100 is described, in accordance with one or more embodiments of the present disclosure. The method 100 may be used to control a thickness of a cascaded MZI filter.

In a step 110, a film is deposited on a substrate. The film may also be referred to as a blanket film. The term blanket film may refer to a blanket layer with or without any pre-patterning. The film may be deposited by a process, such as, but not limited to, a chemical vapor deposition (CVD) process (e.g., low-pressure CVD (LPCVD), plasma enhanced CVD (PECVD), etc.). The film may include any type of film, such as, but not limited to, a silicon nitride (SiN) film. The silicon nitride film may include a composition of silicon and nitrogen (e.g., Si₃N₄). The silicon nitride film may be a thin film. As used herein, thin film may refer to a film with a thickness on the order of a nanometer up to and including several micrometers. For example, the silicon nitride film may include a thickness of around several hundred nanometers (e.g., 400 to 500 nanometers), although this is not intended to be limiting. Undesirably, the silicon nitride film may include non-uniformity across the substrate. The non-uniformity may indicate that the thickness of the film may not be precise everywhere across the substrate and/or includes thickness variations across the substrate. In particular, the film may include an actual thickness which may be larger than a target thickness. The larger actual thickness may undesirably impact one or more characteristics of a structure fabricated from the film. For example, the film may be used to fabricate a cascaded MZI filter. The larger actual thickness may impact the center wavelength of the cascaded MZI filter.

In a step 120, an actual thickness of the film may be measured. The actual thickness may be measured across the wafer or substrate. As used herein, across the wafer or substrate may refer to measurements in one or more regions of the film. For example, the substrate may be broken into several regions to be measured. The regions may be based on a spot size of a tool used to measure the actual thickness, although this is not intended to be limiting. Spot size may refer to a beam diameter of a tool. The actual thickness may be measured by a scanning tool. The scanning tool may scan across the substrate to determine the actual thickness. The scanning tool may determine the actual thickness by performing a measurement across the substrate in the one or more regions. Thus, the substrate may be sampled to determine the difference between the actual thickness and the target thickness of the film. The target thickness may refer to a desired/predetermined level of thickness prior to manufacturing. The target thickness may be selected based on a number of design characteristics, such as, but not limited to, a center wavelength of one or more channels of a wavelength division multiplexer. The scanning tool may include any suitable scanning tool for determining the actual thickness of the film. For example, the scanning tool may include, but is not limited to, an ellipsometer, a reflectometer, a scanning electron microscope, a profilometer, a surface metrology tool, and the like.

In a step 130, the film may be characterized by comparing the actual thickness to the target thickness. A characterization system may compare the actual thickness to the target thickness. The characterization system may measure the thickness throughout the substrate based on the scan of the substrate. The characterization system may include any suitable system for characterizing the thickness, such as, but not limited to an optical characterization system. The scan may be used by the characterization system to determine how much the actual thickness excess the target thickness. A distribution of the difference between the actual thickness and the target thickness may be determined for one or more regions of the film. For example, the distribution may be performed across the wafer.

In a step 140, the actual thickness of the film may be trimmed to within a range or tolerance of the target thickness. The film may be trimmed to within the range or the tolerance based on the characterization. The difference between the actual thickness and the target thickness may be provided to a milling tool from the characterization tool. The milling tool may also be referred to as an ion-beam milling machine. The milling tool may create an ion beam or sputtering beam. The ion beam may knock away the surface layer to reduce the film to within the tolerance of the target thickness. For example, the milling tool may be programmed based on the heights of the various regions. The milling tool may reduce the heights of each of the regions to within the range or the tolerance of the target thickness. The actual thickness of the film may thus be trimmed to within the range or the tolerance of the target thickness. Trimming to the target thickness may allow for precise control of the film to within a select range or select tolerance. The range or the tolerance may be a select value based on a desired characteristic of the film. For example, the tolerance may be within one percent of the target thickness, although this is not intended to be limiting. The range may be between 99 percent to 101 percent of the target thickness. For instance, the range may be between 475.2 nanometers and 484.8 nanometers when the target thickness is 480 nanometers.

In embodiments, the film may be intentionally overgrown in the step 110. The film may be intentionally overgrown to accommodate for process variations and allow for trimming to the target thickness in the step 110. For example, the target thickness may be 400 nanometers. The target thickness may be overgrown by an estimated 20 nanometers to compensate for inaccuracies in the chemical vapor deposition process. In this regard, the chemical vapor deposition may undergrow the film in one or more regions. The target thickness may also be overgrown to allow for milling or trimming.

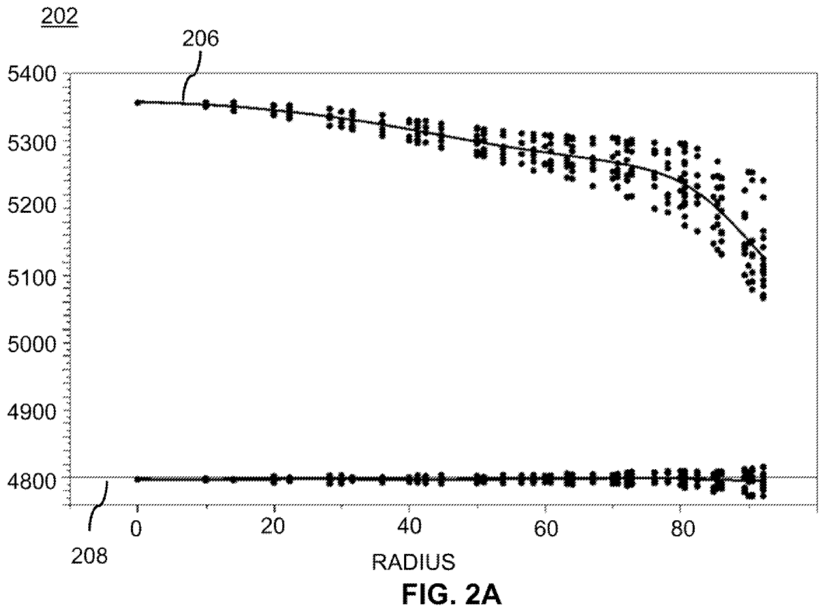

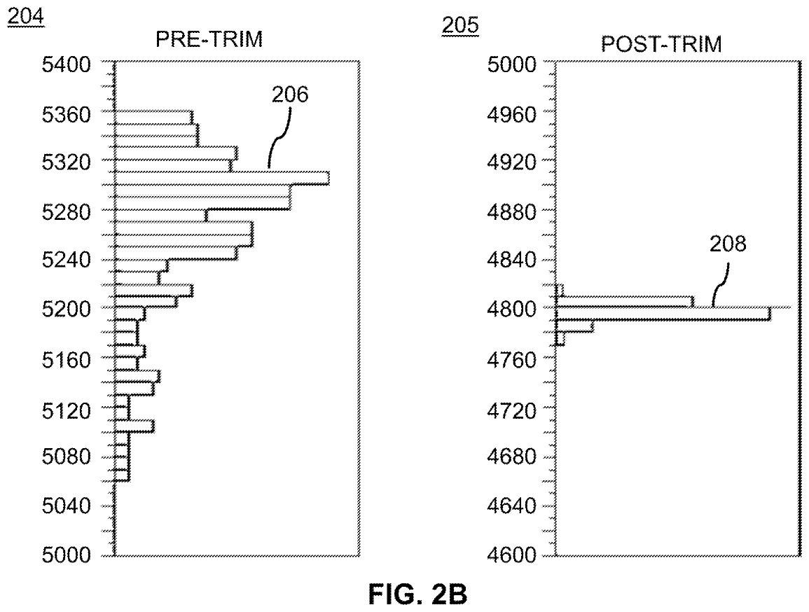

In a step 150, an optical waveguide is fabricated from the film. The optical waveguide may be fabricated by any process. For example, the optical waveguide may be fabricated by a patterning process. The patterning process may include, but is not limited to an etching process (e.g., wet etching, dry etching, etc.), a microfabrication process, and the like. The etching process may be performed by an etching tool. The material remaining after etching may form the optical waveguide. Wet etching may refer to the removal of portions of the film by a liquid chemical or etchant. Dry etching may refer to the removal of portions of the film without a liquid chemical. The dry etching may include any dry etching process, such as, but not limited to, a plasma etching process, a reactive-ion etching process, and the like. The plasma etching process may involve the use of plasma to etch the optical waveguide from the film. Trimming the thickness to within the range of the target thickness may be advantageous to achieve a desired center wavelength for a wavelength division multiplexer of the optical waveguide, which may be further understood with reference to the description of FIGS. 2A-2B.

In embodiments, the optical waveguide may be configured as a wavelength division multiplexer (WDM) for an optical signal. The optical waveguide may be configured for the wavelength division multiplexing by one or more cascaded MZI filters formed from the film. Wavelength division multiplexing may refer to an optical waveguide that may be configured to multiplex and/or demultiplex the optical signal. Undesirably, the thickness variations may impact a center wavelength of the cascaded MZI filters. The optical waveguide may be fabricated to include one or more cascaded Mach-Zehnder interferometers (MZI) filters. For example, the optical waveguide may be fabricated with one or more of the features described further herein, such as, but not limited to, interleaving phase sections of the cascaded MZI filters, using nonlinear tapers, and/or using compact directional couplers.

Although the method 100 is described as being performed by one or more tools, this is not intended as a limitation of the present disclosure. Any one or more of the functionality of the scanning tool, the characterization tool, the milling tool, and/or the etching tool may be combined into a single tool. For example, a metrology tool may include functionality of the scanning tool and the characterization tool, although this is not intended to be limiting.

Referring now to FIG. 2A-2B, a graph 202, a graph 204, and a graph 205 are described, in accordance with one or more embodiments. The graph 202, the graph 204, and the graph 205 may illustrate an example of trimming the cascaded MZI to the target thickness. Trimming to the target thickness may correct for the thickness variations in the film on a waver. As may be understood, the example is not intended to be limiting and is merely illustrative of the concepts described herein. The silicon nitride film used to form the cascaded MZI may include a pre-trimming thickness 206 and a post-trimming thickness 208. The pre-trimming thickness 206 may also be referred to as an actual thickness before trimming. The post-trimming thickness 208 may also be referred to as a target thickness.

The graph 202 may depict the measured values for the pre-trimming thickness 206 to include a film thickness of around 506 nanometers to 536 nanometers. The graph 202 includes the film thickness as a function of radius. As depicted, the film thickness may generally increase with the radius. The graph 204 may further depict a distribution of the pre-trimming thickness 206. The pre-trimming thickness 206 may include one or more statistical values, such as, but not limited to a mean (e.g., 526.13151 nanometers), a standard deviation (e.g., 6.7454216 nanometers), a standard error mean (e.g., 0.4052931 nanometers), and a range (e.g., 29.09785 nanometers).

The graph 202 may further depict the measured values for the post-trimming thickness to include a film thickness of around 478 nanometers to 482 nanometers. The graph 205 may further depict a distribution of the post-trimming thickness. The post-trimming 208 may include one or more statistical values, such as, but not limited to, a mean (e.g., 479.72615 nanometers), a standard deviation (e.g., 0.72001169 nanometers), a standard error mean (e.g., 0.04326131 nanometers), and a range (e.g., 4.41001 nanometers).

In this example, the thickness variation may be reduced from 30 nanometers before trimming to 4 nanometers after trimming. The reduction in thickness variation may be advantageous to achieve a given accuracy in center wavelength for the cascaded MZI. In this example, the target thickness may be 480 nanometers, although this is not intended to be limiting. The film may be considered within tolerance for any of the target thickness, the standard deviation, the standard error mean, and/or the range. For example, the target thickness may include a one percent tolerance, although this is not intended to be limiting. By way of another example, the standard deviation may include a maximum variance of below 1.5 percent at 6σ and/or below 1 percent at 6σ, as will be described further herein. As may be understood, the various values for the pre-trimming thickness 206 and the post-trimming thickness 208 are not intended to be limiting. However, the various values for the mean, standard deviation, the standard error mean, and the range may indicate how, after trimming, the thickness for the cascaded MZI structures may be improved by milling.

The units depicted in the graph 202, graph 204, and the graph 205 may be in angstroms. Appropriate conversion may be made to nanometers.

WDM multiplexing/demultiplexing may require precise thickness control. By trimming the overgrown film to the target thickness, the film may then be used for a WDM application. In some instances, thickness control for the cascaded MZI filter by layout design may be insufficient to meet a desired center wavelength. The use of the method 100 may provide sufficient thickness control by trimming. It is further contemplated that the thickness control may be met by one or more layout designs, as will be further described herein. For example, the optical waveguide may be made as compact as possible to reduce the area of the device. Reducing the area of the optical waveguide may be advantageous in reducing the phase error. Similarly, reducing the phase area may cause a distribution of the center wavelength to be more accurate.

One or more tolerances are now described. Native thickness control on an 8-inch blanket wafers may include a standard deviation of close to 7% (three standard deviations in either direction or 6σ) of targeted thickness using chemical vapor deposition (CVD) type processes (e.g., low pressure chemical vapor deposition (LPCVD, Plasma-enhanced chemical vapor deposition (PECVD) etc.). On wafers with topology (patterning, chemical-mechanical polishing (CMP) etc.), the range may be even higher due to the residual non-uniformity not present on the blanket wafers. For example, a blanket deposition range of 10-15% may be expected over topographic wafers. The blanket deposition range has statistically been observed. Complementary metal-oxide semiconductor (CMOS) foundries may include variances of different types. The variance may be present within a device. For example, a silicon nitride (SiN) thickness variation of up to 5% may be expected in a footprint of 1.6 mm by 1 mm. The variance may also be present adjacent a reticle. For example, up to 7-8% variation may be expected for an inter-reticle separation of around 15 mm. The variance may also be present within a wafer or substrate. For example, up to 15% variance may be expected for an across wafer variance. The variance may also include Wafer-to-Wafer variance and/or Lot-to-Lot variance. The Wafer-to-Wafer variance and/or Lot-to-Lot variance may be similar to within the wafer variance. For example, the Wafer-to-Wafer variance and/or Lot-to-Lot variance may be additionally monitored. Based on experimentation, classical advancements in CMOS processes such as improved CMP processes, slower deposition rates, may be unable to reduce thickness variance across the to below 7% (e.g., at 6σ) from the target thickness.

To realize Multiplexing and Demultiplexing operation without active tuning, a maximum thickness variation may be tolerated across wafer. The maximum thickness variation may refer to a percent standard deviation allowed from a target thickness at a given number of deviations. For example, the maximum thickness variation may be up to 1.5% variance (e.g., at 6σ) from the target thickness, although this is not intended to be limiting. The method 100 may thus be advantageous for improving a uniformity of the film. The trimming by the method may improve the deposited layer uniformity to below 1%. Thus, the trimming may ensure the actual thickness variation may be below the maximum thickness variation allowed for multiplexing and demultiplexing.

Referring now to FIG. 3A, a block diagram of an integrated circuit 300 is described, in accordance with one or more embodiments of the present disclosure. The integrated circuit 300 may also be referred as a chip, a silicon photonics package, and the like. As used herein, an on-chip multiplexer may refer to a multiplexer on the integrated circuit 300 which may be configured to perform multiplexing. Similarly, an on-chip demultiplexer may refer to a demultiplexer on the integrated circuit 300 which may be configured to perform demultiplexing. It is contemplated that the integrated circuit 300 may further include various other functions. For example, the integrated circuit 300 may be used for various communication functions, such as, but not limited to, modulation, receiving light, and the like. The various communication functions may be performed by the integrated circuit 300 using any suitable circuitry.

The integrated circuit may include an optical waveguide 302 on a substrate 304. As used herein, the term “on a substrate” may allow for one or more intervening layers between the optical waveguide 302 and the substrate 304. A layout of the optical waveguide may cause the optical waveguide to be configured as a wavelength division multiplexer (WDM) for an optical signal 306. Advantageously, the layout may cause the WDM to have a center wavelength which may be less sensitive. The center wavelength may be less sensitive to thickness variations of the film in which the optical waveguide 302 may be formed.

The substrate 304 may also be referred to as a die, wafer, blanket wafer, a silicon wafer, and/or a silicon photonics-based wafer. The optical waveguide 302 may be formed on the substrate 304 by any suitable method. For example, the optical waveguide 302 may be formed by the method previously described herein. The optical waveguide 302 may be formed of a film. The film may include, but is not limited to, a silicon nitride (SiN) film. The silicon nitride film may be a thin film (e.g., around 400 nanometer). Wafer may refer to a substrate on which a WDM may be formed. The wafer may be formed of any material, such as, but not limited to, a silicon substrate. In some instances, the substrate 304 may be considered a component of an optical transceiver and/or a co-packaged optics device.

The optical waveguide 302 may provide a signal path for the optical signal 306. The signal path for the signal 306 is depicted as flowing from one input port to four output ports. The optical waveguide 302 may be considered a demultiplexer where the signal flows from one input port to many output ports. As may be understood, this depiction of the demultiplexer is not intended to be limiting. The optical waveguide 302 may also be a multiplexer where the signal path for the signal 306 is reversed (e.g., flow from many input ports to one output port). As used herein, a port may refer to an input and/or an output to an optical waveguide. The port may provide for coupling the optical waveguide to various other components of an integrated circuit. Thus, the port may be used for routing various optical signals. A single port may carry signals with multiple center wavelengths (e.g., multiplexed signals). Multiple ports may each carry signals with separate center wavelengths (e.g., demultiplexed signals).

The optical signal 306 may include one or more bands of light at a given center wavelength. A band of light may refer to light between two wavelengths. The bands of light may also be referred to as a channel. The optical signal 306 may include generally include two or more bands of light. The two or more bands of light may be filtered by the optical waveguide 302 into paths. The bands may generally include any suitable wavelength. One or more exemplary wavelengths will be further described by reference to FIG. 3B. The stages may form any type of filter known in the art. The filter may include, but is not limited to, a bandpass filter. The bandpass filter may include a passband. Frequencies within the passband may not experience significant attenuation from the filter. For example, the filter may cause light to include a gain of at or near zero within the passband. The passband may also include the center wavelength λ and/or a center frequency. The center frequency may be disposed between upper and lower cutoff frequencies for the passband (e.g., an arithmetic mean and/or geometric mean of the cutoff frequency). The bandpass filter may also include a stopband. The stopband may be provided on each side of the passband. Frequencies/wavelengths within the stopband may experience significantly more attenuation than frequencies/wavelengths within the passband. The filter may thus be used to filter the bands of light by the stopband and the passband.

The optical waveguide 302 may include one or more stages (S). The one or more stages (S) may filter the light into the paths. Filtering the light may also be referred to herein as splitting the optical signal 306 into channels where the optical waveguide is configured as a demultiplexer. Similarly, filtering the light may also be referred to as combining the channels of the optical signal 306 where the optical waveguide is configured as a multiplexer. As used herein, stages may refer to a multiplexer/demultiplexing stage in the optical waveguide. The stage may generally include one or more cascaded MZI. For instance, the stage may include a cascaded MZI which may be doubled in a binary tree configuration, although this is not intended to be limiting. A binary tree configuration may refer to a stage (S) which has two outputs which are each coupled to a duplicate stage (S). The optical filter may also include separate stage (e.g., stage (S1) followed by stage (S2). The separate stages may be arranged in sequence to increase the number of channels capable of being multiplexed/demultiplexed. As used herein, channel may refer to an optical communications channel carried over a same medium. The channel may convey information, such as a bit stream. The channel may include various performance characteristics, such as, but not limited to, a bandwidth and the center wavelength.

In the example depicted, the optical signal includes four bands of light at wavelengths λ1, λ2, λ3, and λ4. In the example depicted, the optical waveguide 302 also includes a first stage (S1) and a second stage (S2A, S2B). The various stages may split the signal into various channels with a corresponding center wavelength. The example depicted also shows the first stage (S1) being doubled in the binary tree. The example depicted also shows each of the second stage (S2A, S2B) being doubled in the binary tree.

The first stage (S1) may split the optical signal 306 into odd channels and even channels. As may be understood, the terms odd and even are not intended to be limiting, but are merely a shorthand for referring to the channels with the corresponding center wavelengths λ1, λ2, λ3, λ4. The odd channels may refer to a first channel with the center wavelength λ1 and a third channel with the center wavelength λ3. The even channels may refer to a second channel with the center wavelength λ2 and a fourth channel with the center wavelength λ4. In this regard, the first stage (S1) may include a path with a passband for the channels with the center wavelengths λ1 and λ3, together with an additional path with a passband for the channels with the center wavelengths λ2 and λ4.

In the second stage (S2A), the first channel may be split from the third channel. In this regard, the second stage (S2A) may include a path with a passband for the channel with the center wavelength λ1, together with an additional path with a passband for channel with the center wavelength λ3. In the second stage (S2B), the second channel may be split from the fourth channel. In this regard, the second stage (S2B) may include a path with a passband for channel with the center wavelength λ2, together with an additional path with a passband for the channel with the center wavelength λ4. Thus, the optical signal may be demultiplexed into the four channels.

The various stages of the optical waveguide 302 may generally include any one or more of components which are described further herein. For example, the stages may include any one or more of a phase section, taper (e.g., linear taper, nonlinear taper), directional coupler (e.g., u-bend coupler or compact directional coupler, s-bend coupler), folded structures, stage doubling, and the like.

The first stage S1 may be doubled. Similarly, the second stage (S2A) and/or (S2B) may be doubled. As used herein, doubling a stage may refer to first cascaded MZI filter which performs an initial pass band filtering, splitting the signal into two paths for separate channels, and then applying a pair of second cascaded MZI filters to each of the two paths. The first cascaded MZI filter and the pair of second cascaded MZI filters may each include the same passband for improving the crosstalk. For example, FIG. 3A depicts three blocks of filters for the first stage (S1). By way of another example, FIG. 3A depicts three blocks of filters for the top path of the second stage (S2A). By way of another example, FIG. 3A depicts three blocks of filters for the bottom path of the second stage (S2B). The various stages may be doubled to improve crosstalk, as is known in the art. As used herein, crosstalk may refer to passing signals between paths (e.g., signals outside of the passband).

Referring now to FIG. 3B, an exemplary transmission spectrum 308 of the optical waveguide 302 is described, in accordance with one or more embodiments of the present disclosure. The exemplary transmission spectrum 308 is depicted with four passbands. For example, the four passbands may correspond to the center wavelengths λ1 of 1271 nanometers, λ2 of 1291 nanometers, λ3 of 1311 nanometers, and λ4 of 1331 nanometers, although this is not intended to be limiting. The passband width for each channel is also depicted. For example, the passband width for each channel may be 20 nanometers, although this is not intended to be limiting. The transmission loss in decibels within the passband may be substantially near zero. The transmission loss in decibels outside of the passband may decrease below zero. As may be understood, the channel spacing described is not intended to be limiting and is merely provided for illustration. The channel spacing may be decreased to increase the density of the channels where the number of stages/channels is increased. For example, the channel spacing has been described as being 20 nanometers. The channel spacing may be changed to be on the order of 2 nanometers, 10 nanometers, 20 nanometers, or a number therebetween. One challenge with implementing the optical waveguide 302 may be allowing for larger channel spacing.

The optical waveguide 302 may also permit higher and lower passbands. A higher passband may refer to a range of wavelengths that pass through the filter which may be higher than a desired passband. Similarly, a lower passband may refer to a range of wavelengths that pass through the filter which may be lower than a desired passband. For example, the filter for the wavelength λ1 is depicted as including a higher passband. The higher passband is depicted above the wavelength λ4. By way of another example, the filter for the wavelength λ4 is depicted as including a lower passband. The lower passband is depicted below the wavelength λ1. As may be understood, the higher and lower passbands are not intended to be limiting.

Referring now to FIGS. 4A-4B, a schematic diagram of a MZI filter 400 is described, in accordance with one or more embodiments of the present disclosure. As may be understood, the various patterns (e.g., thatching, dots, lines, etc.) depicted in FIG. 4B is not intended to be limiting. The various patterns are merely provided for illustrating the various sections of the MZI filter 400. It is to be further understood that each of the various sections may be formed of the same material. For example, the material may include, but is not limited to, the silicon nitride (SiN) film. In this regard, the term section is not intended to be limiting in that the sections may generally be formed of a continuous layer of silicon nitride film.

Each stage of the optical waveguide 302 may include one or more of the MZI filters 400. The MZI filter 400 may include one or more sections. The one or more sections may include, but are not limited to not limited to, a bend 402, a taper 404, a phase section 406, and/or a bent section 408. The MZI filter 400 may function as a splitter and recombiner for an optical signal by the various sections. The MZI filter 400 may also be configured with one or more passbands and/or stopbands by the various sections.

The bend 402 may couple the MZI filter 400 to one or more other portions of the optical waveguide 302. For example, the bend 402 may couple the MZI filter 400 to a directional coupler. The directional coupler may then be used to form a cascaded MZI by cascading multiple of the MZI filters 400 (e.g., at least two) in sequence. The bend 402 may also be coupled to one or more sections of the MZI filter 400. For example, the bend 402 may be coupled to the taper 404.

The MZI filter 400 may also include a taper 404. The taper 404 may couple various sections of the MZI filter 400. For example, the taper 404 may be coupled between the phase section 406 and the bent section 408. By way of another example, the taper 404 may be coupled between the phase section 406 and the bend 402. By way of another example, the taper 404 may be coupled between the phase section 406 and another tapers. By way of another example, the taper 404 may be coupled between another taper and the bent section 408. The taper 404 may also provide a transition between relatively thinner and relatively thicker sections of the optical waveguide.

Each phase section 406 may include a length. The length of the phase sections 406 may be selected to generate a desired passband. Each phase section 406 may also include a width. In this regard, the term phase section may refer to a section which is straight with a given width. The phase section 406 may include one or more phase sections, such as a phase section 406a and/or a phase section 406b. The phase section 406a may also be referred to as a waveguide section, thicker phase section, a main phase section, a phase section of a top arm, or some combination therein. The phase section 406b may also be referred to waveguide section, a thinner phase section, a compensating phase section, or some combination therein. The width and/or length of the phase section 406a and/or the phase section 406b may be selected for phase compensation, as will be described further herein.

The bent section 408 may couple one or more sections of the MZI filter 400. For example, the bent section 408 may be coupled between the taper 404 and another taper.

As depicted, the MZI filter 400 includes a top arm 401a and a bottom arm 401b. As used herein, arm may also be referred to as a path for optical signals. The use of the terms top and bottom is not intended to be limiting. For example, top and bottom may be merely illustrative of the relative locations of the arms. A cascaded MZI may generally include two paths for the optical signal by the top and bottom arms.

The top arm 401a may provide a first path for the optical signal. On the top arm 401a, a taper 404a may be coupled between the bend 402 and the phase section 406a. Also on the top arm 401a, the phase section 406b may be coupled between the taper 404a and a taper 404b. Also on the top arm 401a, the taper 404b may be coupled between the phase section 406a and the bent section 408.

The bottom arm 401b may provide a second path for the optical signal. On the bottom arm 401b, the phase section 406b may be coupled between the bend 402 and the taper 404c. Also on the bottom arm 401b, the taper 404c may be coupled between the phase section 406b and a taper 404d. Also on the bottom arm, the taper 404d may be coupled between the taper 404c and the bent section 408.

In embodiments, a symmetric design may be used for one or more components of the MZI filter 400. Symmetric may refer to equal phase error contribution due to the bent sections 408 on the top path and the bottom path. Symmetric may also refer to equal phase error contribution due to the tapers 404 on the top path 401a and the bottom path 401b. The symmetric design may use the same type of bent sections 408 and/or the same type of tapers 404 on all paths. In the symmetric design, the lengths and/or widths of the phase section 406 may be different. The lengths and/or widths may be different to filter the various channels at the passbands. Furthermore, a layout for an optical waveguide including a plurality of stages each with the one or more of the MZI filters may use the symmetric design for the bent sections 408 and tapers 406. The use of the symmetric design may be advantageous such that the phase error in the bent section 408 may cancel out. Similarly, the phase error in the tapers 406 may cancel each out. It is further contemplated that the design may be non-symmetric. The non-symmetric design may refer to a non-equal phase error contribution due to bands and/or tapers among the top and bottom paths. However, the phase error may be more difficult to control for non-symmetric designs. Additionally, the symmetric design may be advantageous in allowing for phase error compensation.

In embodiments, the MZI filter 400 may be phase compensated. A technique for improving fabrication tolerance may include phase compensation. One or more phase sections of the cascaded MZI may be phase compensated. The phase errors caused by the fabrication tolerances of the waveguide width and sidewall angle variations may be compensated by design. The phase sections may include different widths and may be used on two arms of the MZI. Phase errors due to width and sidewall angle variations may be compensated using phase sections based on the widths and lengths of the phase section 406 of the MZI filter 400. The phase compensation may occur with different widths on the upper and lower arms as described below. More particularly, the lengths of the phase sections may be designed to eliminate the numerator in the following equation:

$$Δ λ / Δ w = {λ}_{0} ( \frac{\partial {n}_{1}}{\partial {w}_{1}} {L}_{1} - \frac{\partial {n}_{2}}{\partial {w}_{2}} {L}_{2} ) / ( {n}_{g , 1} {L}_{1} - {n}_{g , 2} {L}_{2} )$$

The variables of the above equation will now be described. Delta lambda (Δλ) is the wavelength change. Delta w (Δw) is the width change. Therefore, delta lambda over delta w (Δλ/Δw) may indicate how much the center wavelength will shift if the width of the waveguide is changed. The equation depends on the phase difference between the top arm and the bottom arm. (n1) is the index of the top arm. Delta n1 (δn1) is the index change on the top arm. (w1) is the width of the phase section 406a of the top arm. Delta w1 (δw1) indicates a change in the width of the top arm. (n2) is the index of the top arm. Delta n2 (δn2) is the index change on the bottom arm. (w2) is the width of the phase section 406b of the bottom arm. Delta w2 (δw2) indicates a change in the width of the top arm. (L1) is the length of the phase section 406a of the top arm. (L2) is the length of the phase section 406b of the bottom arm. (δn1/Δw1*L1) is the total index change when the width or length of the phase section 406a of the top arm is changed. Similarly, (δn2/δw2*L2) is the total index change when the width or length of the phase section 406b of the bottom arm is changed. n_{g,1} is the group index of the phase section 406a of the top arm. n_{g,2} is the group index of the phase section 406b of the bottom arm.

In some instances, the top arm 401a may be considered thicker waveguide path and the bottom arm 401b may be considered the thinner waveguide path. Where the phase section 406a of the top arm 401a is thicker than the phase section 406b of the bottom arm 401b, w1 is greater than w2. Changes in the width w1 and the width w2 may impact the index changes. The index change (δn1/δw1*L1) to the top arm 401a and the index change (δn2/δw2*L2) to the bottom arm 401b may be different when the width of w1 and w2 are changed by the same amount (e.g., δw1=δw2). Similarly, the widths will contribute different amounts to the shift in the center wavelength Δλ. In some instances, the top arm 401a may be considered a multimode path. Mode may refer to a guided optical field which propagates within a material without significant loss. The number of modes may be dependent upon a number of factors, such as, but not limited to, signal wavelength and dimensions of the path.

In embodiments, the width (w1), the width (w2, the length (L1), and the length (L2) may be selected to cancel out one or more factors. For example, the various dimensions may be selected to cancel out the index change (δn1/δw1*L1) to the top arm 401a with the index change (δn2/δw2*L2) to the bottom arm 401b. The index change (δn1/δw1*L1) may cancel with the index change (δn2/δw2*L2) when the index change (δn1/δw1*L1) is equal to the index change (δn2/δw2*L2), as illustrated by the above equation for delta lambda over delta w (Δλ/Δw). Advantageously, by cancelling out the index changes to the top and bottom arms, there will be no change to the center wavelength (Δλ) when changing the width (Δw). This may also be referred to herein as phase compensation. As may be understood, the width may be inadvertently changed due to process variations during fabrication. Thus, cancelling out the index change (δn1/δw1*L1) with the index change (δn2/δw2*L2) by the layout may allow for limiting variations in center wavelength, even where the waveguide includes undesirable process variations.

It is further contemplated that the phase compensation may be advantageous when used in combination with thickness control. For example, the waveguide width variation may be minimally impacted by the sidewall angle when the thickness may be controlled. In this regard, the method 100 may be advantageous when used in combination with optical waveguide 302.

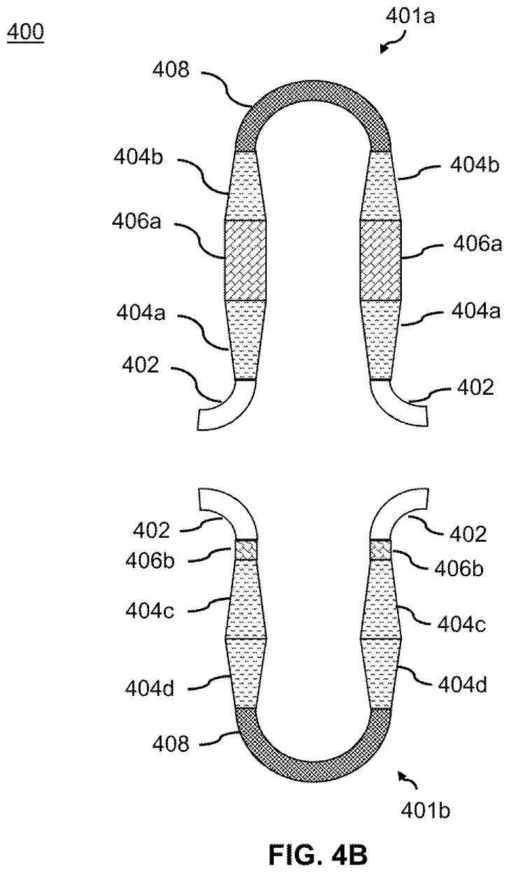

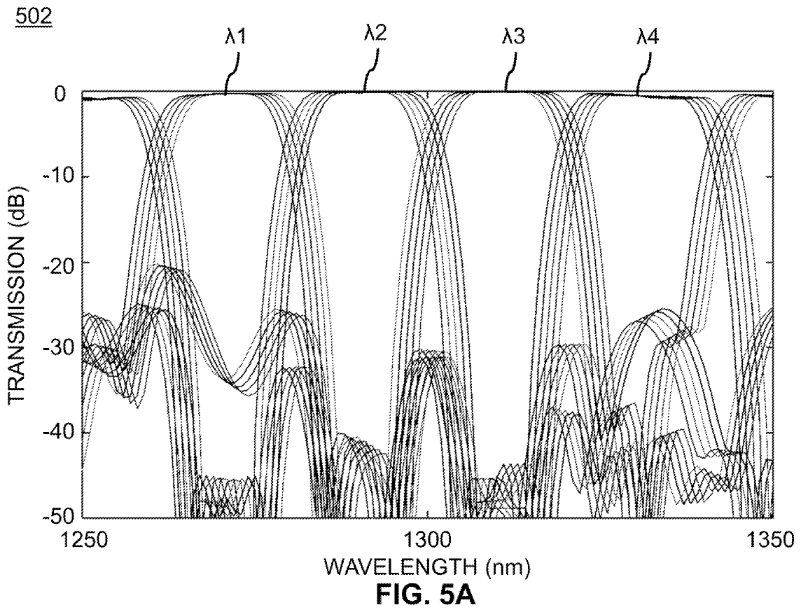

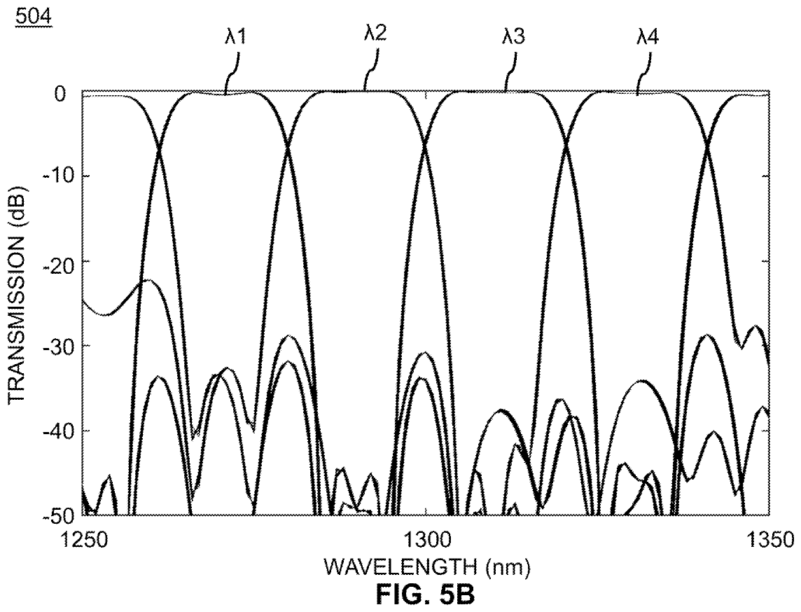

Referring now to FIG. 5A-5B, a graph 502 and a graph 504 are described, in accordance with one or more embodiments. The graph 502 may illustrate a transmission spectrum without phase compensation. The graph 504 may illustrate a transmission spectrum with phase compensation. Comparing the graph 502 with the graph 504 is illustrative that phase compensation may be used to improve the accuracy of the center wavelengths (λ1, λ2, λ3, λ4).

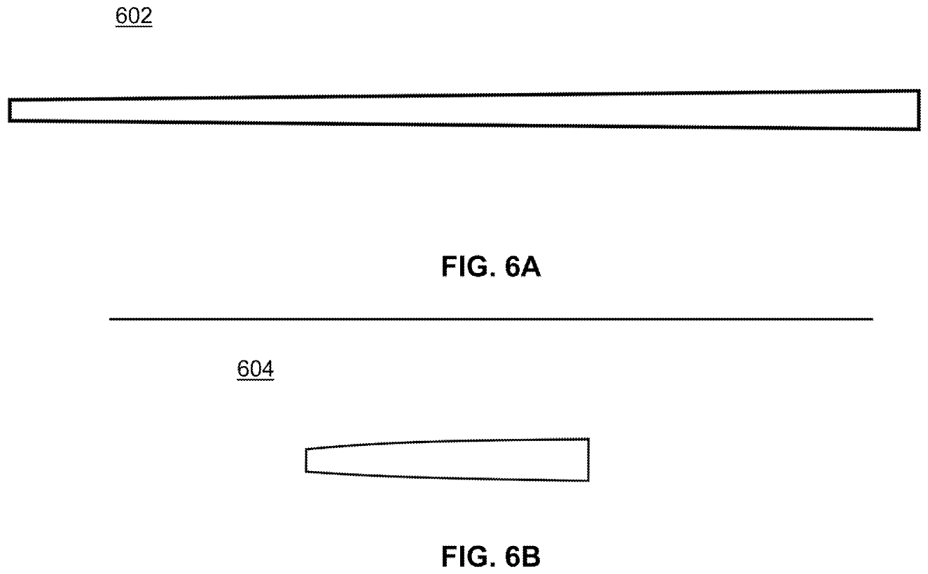

Referring now to FIG. 6A-6B, the taper 404 is described, in accordance with one or more embodiments of the present disclosure. It is contemplated that the taper 404 may be a linear taper 602, a nonlinear taper 604, and the like. The tapers may be provided for increasing and/or decreasing a width of the optical waveguide 302. The tapers may have a given length to achieve a low loss.

In some embodiments, the taper may be a linear taper 602. A linear taper may refer to connecting a thinner section of the optical waveguide to a thicker section of the optical waveguide by a straight line. Similarly, thicker sections may be coupled to the thinner sections by the linear taper 602. The linear taper 602 may thus transition the thinner section to the thicker section of the optical waveguide.

In some embodiments, the taper may be a nonlinear taper 604. Similar to the linear taper 602, the nonlinear taper 604 may be provided for increasing or decreasing a width of the optical waveguide. The nonlinear taper may be a precise geometrical shape regarding how the pattern may be laid down on the wafer. As depicted, the nonlinear taper 604 may include a convex taper. The nonlinear taper 604 may thus include a width which increases nonlinearly along the length of the taper.

The nonlinear taper 604 may be relatively short when compared to the linear taper 602. For example, the linear taper 602 may have a length of between 20 to 30 microns. In contrast, the nonlinear taper 604 may have a length of between 5 to 6 microns. The nonlinear taper 604 may thus cause a transition length between the phase section to the bandings to be reduced. Advantageously, the nonlinear taper 604 may have a reduced length when compared to the linear taper 602 without increasing signal loss (e.g., decibels or dB). Reducing the transition may similarly reduce an area of the MZI. Thus, the nonlinear taper may be advantageous for increasing the accuracy of the center wavelength without increasing the loss through the taper.

The optical waveguide 302 may use multiple of the tapers 404. Therefore, the use of the nonlinear taper 604 may result in a significant reduction in the taper length and similarly a reduction of the footprint and/or area of the optical waveguide 302. For example, between 14 to 25 microns may be saved for each taper 404 by switching from the linear taper 602 to the non-linear taper 604. The use of the nonlinear taper 604 may thus provide an improvement in the center wavelength of the optical waveguide 302 due to a reduced likelihood of process variations stemming from the reduction in the footprint.

Referring now to FIGS. 7A-7B, an Nth order filter is described, in accordance with one or more embodiments of the present disclosure. Nth order may refer to cascading N of the MZI filters 400 together. In embodiments, each stage of the optical waveguide includes multiple of the MZI filters 400. The multiple MZI filters 400 may be provided in sequence with each other. The MZI filters 400 may also be coupled by a directional coupler 706, as will be described further herein. The term directional coupler may indicate a coupler in which two paths are located close to each other for light to couple from one path to another path. The directional coupler 706 may include a coupling length over which light from the paths may leak and interact. The directional coupler 706 may be used to split and combine the optical signal between the MZI filters 400 within each stage. The directional coupler 706 may be implemented in each stage for coupling the MZI filters 400 to form the Nth order filter. The directional coupler 706 may also refer to a fused coupler of an optical waveguide.

Coupling multiple of the MZI filters 400 in sequence may form a cascaded MZI filter. Cascading may refer to coupling multiple MZI filters 400 in sequence. The cascaded MZI filter may be known as an Nth order filter. N may refer to the number of the MZI filters in sequence. An Nth order filter may be formed by cascading N phase sections together. The Nth order filter may include N+1 of the directional coupler 706, such that each stage may be split and combined into the (N) MZI filters. The Nth order filter may have a response. The response may be based on the number of MZI filters cascaded in sequence. Increasing the Nth order to higher orders may generally improve the response. For example, higher orders (e.g., third order or higher) may include the flattop response. The flattop response may allow the passband at the desired center wavelength. Additionally, the higher order cascaded MZI filters may enable sufficiently wide passbands (e.g., 20 nanometers or more).

As depicted in FIG. 7A, the Nth order filter may include a fourth order filter 702. The fourth order filter 702 may be formed of four phase sections which may be cascaded together by five of the directional couplers 706. As depicted in FIG. 7B, the Nth order filter may include a third order filter 704. The third order filter 704 may be formed by three phase sections which may be cascaded together by four of the directional couplers 706. Increasing the order of the filter may cause the passband of the filter to be increased. Increasing the order of the filter may also introduce a possibility for phase errors which may contribute to the center wavelength accuracy. The possibility for phase errors may be due to the increased number of MZI filters, and similarly an increase in the footprint.

The concepts described herein may generally apply to any order of cascaded MZI filter. For example, the cascaded MZI filter may include a second order, third order, fourth order, or a higher order filter. Thus, the Nth order filter may be cascaded for any given order to achieve a desired response. The desired response may include, but is not limited to, a passband and/or a center wavelength accuracy. As may be understood, the number of the directional couplers 706 may increase with the order of the cascaded MZI filter.

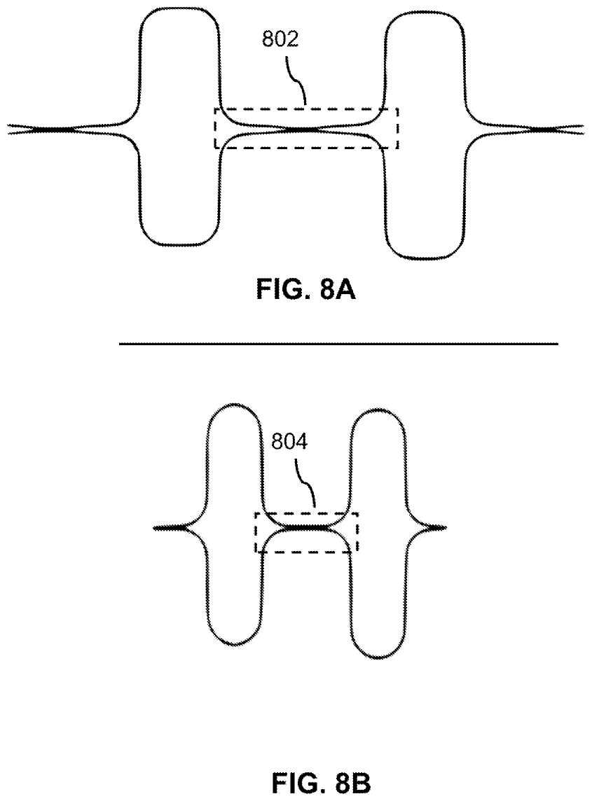

Referring now to FIGS. 8A-8B, the directional coupler 706 is described, in accordance with one or more embodiments of the present disclosure. The choice of the directional coupler 706 may have implications in the context of optical systems. The directional coupler 802 may include an S-bend coupler 802 and/or a U-Bend coupler 804.

The S-bend coupler 802 may be a relatively non-compact directional coupler. The S-bend coupler 802 may require a relatively long distance from the input to the output. After the S-bend coupler 802, a 90-degree bend may be used to connect the S-bend coupler 802 to the phase section on the top arm and on the bottom arm.

The U-bend coupler may be relatively more compact than the S-bend coupler. In this regard, the U-bend coupler may also be referred to herein as a compact directional coupler.

Any combination of the S-bend couplers 802 and/or U-Bend couplers 804 may be used for coupling the MZI filters. For example, the S-bend couplers 802 may be used on the input side and the output side for each MZI filter. In embodiments, the U-bend coupler 804 may be used on the input side and the output side of each MZI filter. The use of the U-bend coupler 804 may reduce the length and/or area of the optical waveguide 302 as compared to the S-bend coupler 802. Thus, the U-bend coupler 804 may be advantageous in improving the center wavelength due to a reduced likelihood of process variations.

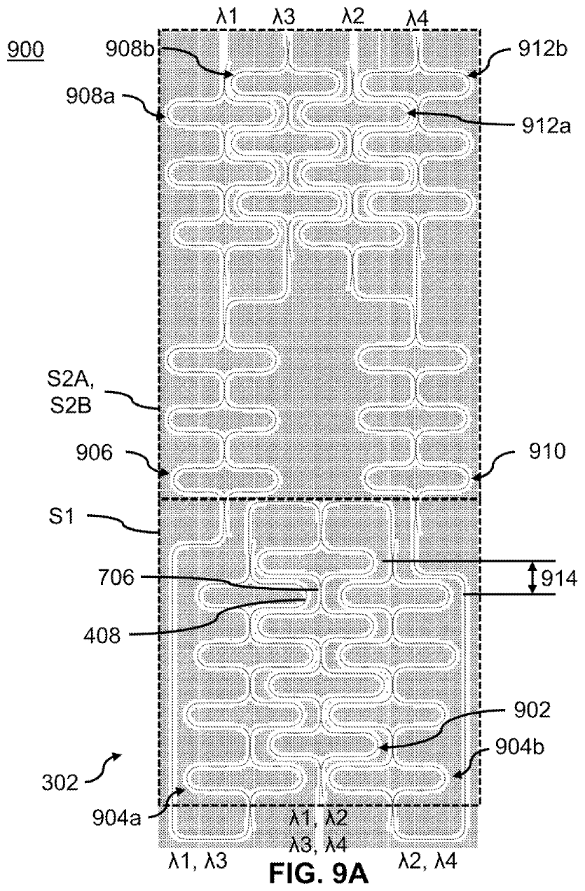

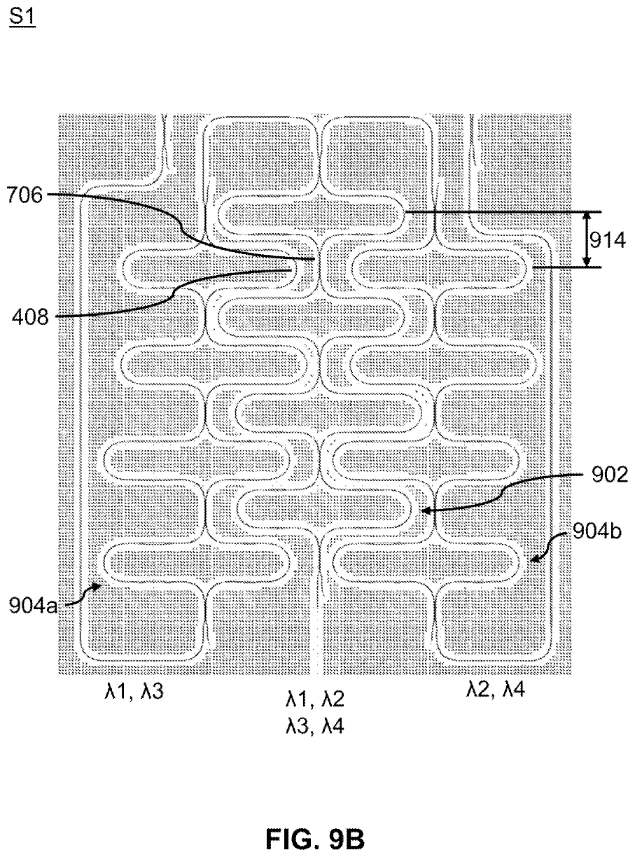

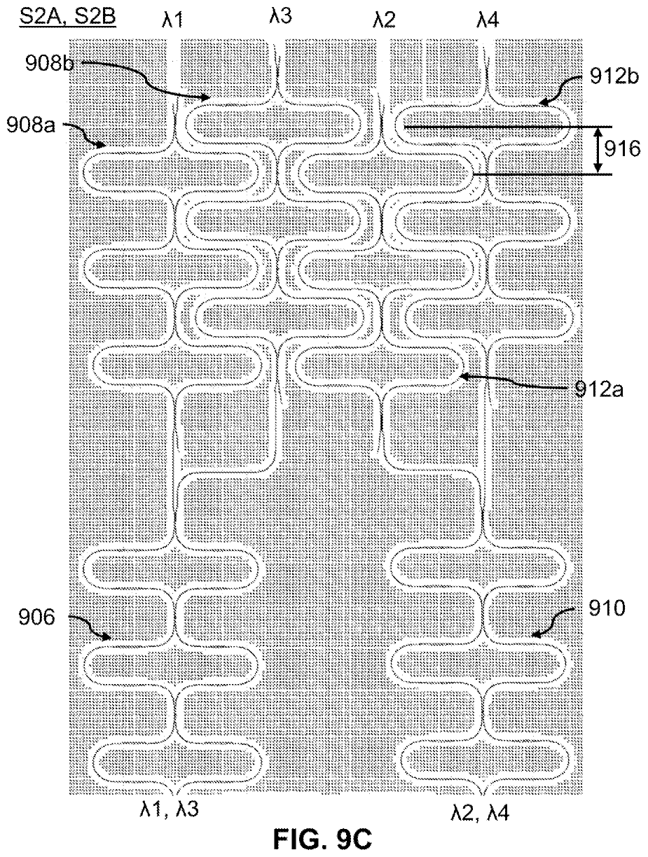

Referring now to FIGS. 9A-9C, a layout 900 of the optical waveguide 302 is described, in accordance with one or more embodiments of the present disclosure. The layout 900 may be exemplary of one or more embodiments of the present disclosure. The layout 900 may include an optical waveguide configured as a wavelength division multiplexer by one or more cascaded MZI filters. The layout 900 will generally be described as a demultiplexer for the sake of convenience, although this is not intended to be limiting. The layout 900 may similarly function as a multiplexer by inverting the signal path. The layout 900 may be considered a two-stage optical waveguide and/or a 4-channel optical waveguide. Two-stage may refer to an optical waveguide including a stage (S1) and a stage (S2A, S2B). The stage (S2A, S2B) may be coupled to the stage (S1) in series. Each of the stage (S1) and the stage (S2A, S2B) may also be stage doubled in the binary tree configuration.

The optical waveguide 302 may include a port configured to receive and/or transmit a multiplexed channel. The multiplexed channel may include multiple center wavelengths (e.g., λ1, λ2, λ3, and λ4). The port may be considered an input port where the optical waveguide is a demultiplexer. The port may be considered an output port where the optical waveguide is a multiplexer.

Similarly, the optical waveguide 302 may include four ports each configured to receive and/or transmit a demultiplexed channel. Each of the demultiplexed channels may include a center wavelength (e.g., λ1, λ2, λ3, and λ4). Each of the ports may be considered an output port where the optical waveguide is a demultiplexer. Each of the ports may be considered an input port where the optical waveguide is a multiplexer.

In embodiments stage (S1) and/or the stage (S2A, S2B) includes a third order filter and/or a fourth order filter. As may be understood, the description and depictions of the fourth and third order filters are not intended to be limiting. The stage (S1), the stage (S2A), and the stage (S2B) may generally include any Nth order filter to achieve a desired passband.

The optical waveguide 302 may include the stage (S1). The stage (S1) is depicted with fourth order filters, although this is not intended to be limiting. The stage (S1) may also be doubled. In this example, the stage (S1) includes a cascaded MZI filter 902. The cascaded MZI filter 902 may be coupled the port. By the coupling, the cascaded MZI filter 902 may receive the channels with the center wavelengths (e.g., λ1, λ2, λ3, and λ4). The cascaded MZI filter 902 may also be coupled to a pair of cascaded MZI filters 904 (e.g., cascaded MZI filter 904a, cascaded MZI filter 904b). In this regard, the cascaded MZI filter 902 may be doubled with the pair of cascaded MZI filters 904. The stage (S1) may then split the odd and even channels. The stage (S1) may split the channels with the center wavelengths (λ1, λ3) from the channels with the center wavelengths (λ2, λ4). The stage (S1) may split the center wavelengths by the cascaded MZI filter 902 and/or the pair of cascaded MZI filters 904. In this regard, the cascaded MZI filter 902 may include a path with a passband for the center wavelengths λ1 and λ3, together with an additional path with a passband for the center wavelengths λ2 and λ4. Similarly, the cascaded MZI filter 904a may include a path with a passband for the center wavelengths λ1 and λ3. Similarly, the cascaded MZI filter 904b may include a path with a passband for the center wavelengths λ2 and λ4.

The optical waveguide 302 may include the pair of second stages (S2A, S2B). The stage (S2A) and the stage (S2B) are each depicted with third order filters, although this is not intended to be limiting. Each of the stage (S2A) and the stage (S2B) may also be doubled.

In this example, the stage (S2A) includes a cascaded MZI filter 906. The cascaded MZI filter 906 may be coupled to the cascaded MZI filters 904a from the stage (S1). By the coupling, the cascaded MZI filter 906 may receive the odd channels with the center wavelengths (λ1, λ3). The stage (S2A) may also include a pair of cascaded MZI filters 908 (e.g., cascaded MZI filter 908a, cascaded MZI filter 908b). The pair of cascaded MZI filters 908 may each be coupled to the cascaded MZI filter 906. In this regard, the cascaded MZI filter 906 may be doubled with the pair of cascaded MZI filters 908. The stage (S2A) may split the channel with the center wavelength (λ1) from the channel with the center wavelength (λ3). The stage (S2A) may split the center wavelengths by the cascaded MZI filter 906 and/or the pair of cascaded MZI filters 908. In this regard, the cascaded MZI filter 906 may include a path with a passband for the center wavelength λ1, together with an additional path with a passband for the center wavelength λ3. Similarly, the cascaded MZI filter 908a may include a path with a passband for the center wavelength λ1. Similarly, the cascaded MZI filter 908a may include a path with a passband for the center wavelength λ3.

The stage (S2B) may be in a similar configuration as the stage (S2A). However, the stage (S2B) may include paths with different passbands than the stage (S2A). The stage (S2B) may include a cascaded MZI filter 910. The cascaded MZI filter 910 may be coupled to the cascaded MZI filter 904b from the stage (S1). By the coupling, the cascaded MZI filter 910 may receive the even channels with the center wavelengths (λ2, λ4). The stage (S2B) may also include a pair of cascaded MZI filters 912 (e.g., cascaded MZI filter 912a, cascaded MZI filter 912b). The pair of cascaded MZI filters 912 may each be coupled to the cascaded MZI filter 910. In this regard, the cascaded MZI filter 910 may be doubled with the pair of cascaded MZI filters 912. The stage (S2B) may split the channel with the center wavelength (λ2) from the channel with the center wavelength (λ4). The stage (S2B) may split the center wavelengths by the cascaded MZI filter 910 and/or the pair of cascaded MZI filters 912. In this regard, the cascaded MZI filter 910 may include a path with a passband for the center wavelength λ2, together with an additional path with a passband for the center wavelength λ4. Similarly, the cascaded MZI filter 912a may include a path with a passband for the center wavelength λ2. Similarly, the cascaded MZI filter 912b may include a path with a passband for the center wavelength λ4.

In embodiments, a second portion of the stage (S1) may be folded backwards onto a first portion. For example, the pair of cascaded MZI filters 904 of the stage (S1) are depicted as folded backwards. The pair of cascaded MZI filters 904 may be folded backwards from the fourth order filters 902. In particular, the output of the cascaded MZI filter 902 may be coupled to the pair of cascaded MZI filters 904 by a U-bend. As used herein, the term folded backwards may refer to a direction relative to the port with the wavelengths (λ1, λ2, λ3, and λ4). Folding the pair of cascaded MZI filters 904 backwards from the cascaded MZI filter 902 may reduce an area of the layout 900. The pair of fourth order filters 902 may then be coupled to the stage (S2A) and/or the stage (S2B) by one or more U-bends, S-Bends, or another type of coupling.

As used herein, interleave may refer to placing cascaded MZI filters adjacent to and offset from another cascaded MZI filter. Interleaving may also be referred to as intertwining or interlacing. It is contemplated that cascaded MZI filters may be interleaved to reduce a footprint of the optical waveguide. In embodiments, cascaded MZI filters in a stage may be interleaved with cascaded MZI filters within the stage and/or with cascaded MZI filters outside of the stage. For example, a cascaded MZI filter may be interleaved with another cascaded MZI filter within the stage (e.g., where the stage may be a second stage or higher). This example will be further described herein by reference to the layout 900. By way of another example, a cascaded MZI filter may be interleaved with a doubled cascaded MZI filter in the stage (e.g., where the stage may be a first stage or higher). This example will be further described herein by reference to the layout 900. It is further contemplated that cascaded MZI filters may be interleaved between stages, although this is not depicted.

In embodiments, the pair of cascaded MZI filters 904 of the stage (S1) may be interleaved with the cascaded MZI filter 902 of the stage (S1). Notably, the cascaded MZI filter 902 may be offset a distance 914 from the pair of the cascaded MZI filters 904. Offset may refer to a distance between components. Offset may indicate phase sections of cascaded MZI filters may not be aligned. In particular, the offset relationship may allow the bent section 408 to be adjacent to the directional couplers 706. The interleaving may allow for a relatively compact layout, which may further improve the center wavelength. For example, a width of the layout 900 may be reduced, as compared to a layout which does not use the interleaving.

Similar to the stage (S1), the stage (S2A) and/or the stage (S2B) may include one or more cascaded MZI filters which interleaved together. The cascaded MZI filters may be interleaved by being offset. The cascaded MZI filters may be offset by a distance 916. In embodiments, the pair of cascaded MZI filters 908 of the stage (S2A) may be interleaved together. In embodiments, the cascaded MZI filter 908b of the stage (S2A) may be interleaved with the cascaded MZI filter 912a of the stage (S2B). In embodiments, the pair of cascaded MZI filters 912 of the stage (S2B) may be interleaved together. Any one or more of the pair of cascaded MZI filters 908, the cascaded MZI filter 908b with the cascaded MZI filter 912a, and/or the pair of cascaded MZI filters 912 may be interleaved by being offset by the distance 916. Interleaving any one or more of the pair of cascaded MZI filters 908, the cascaded MZI filter 908b with the cascaded MZI filter 912a, and/or the pair of cascaded MZI filters 912 may further reduce an area of the optical waveguide 302. Thus, the interleaving the various cascaded MZI filters of the stage (S2A) and the stage (S2B) may improve the accuracy of the center wavelengths (λ1, λ2, λ3, and λ4).

The combination of interleaving/folding backwards the pair of cascaded MZI filters 904 together with the interleaving of the various cascaded MZI filters of the stage (S2A) and the stage (S2B) is contemplated to minimize the footprint (e.g., width and length) of the layout 900.

In embodiments, the layout 900 may include the nonlinear taper 604. In embodiments, the layout 900 may include the U-bend couplers 804.

By the various embodiments alone or in combination, the layout 900 may have a footprint of 1.6 millimeters×0.6 millimeters. The footprint may be achieved while using 4th order filters for the stage (S1) with stage doubling together with 3rd order filters for the stage (S2A) and (S2B) each with stage doubling. As may be understood, the footprint is not intended to be limiting, but is illustrative of the relatively compact size achievable by the various embodiments. The layout 900 of the two-stage optical waveguide may be particularly advantageous for achieving a demultiplexer configured to demultiplex four channels from a multiplexed signal. The layout 900 may also provide demultiplexing with a given level of accuracy for the channels.

In some instances, the cascaded MZI filter 902 may be referred to as a first cascaded MZI filter. In some instances, the cascaded MZI filter 904a may be referred to as a first of a first pair of cascaded MZI filters. In some instances, the cascaded MZI filter 904b may be referred to as a second of a first pair of cascaded MZI filters. In some instances, the cascaded MZI filter 906 may be referred to as a second cascaded MZI filter. In some instances, the cascaded MZI filter 908a may be referred to as a first of a second pair of cascaded MZI filters. In some instances, the cascaded MZI filter 908b may be referred to as a second of a second pair of cascaded MZI filters. In some instances, the cascaded MZI filter 910 may be referred to as a third cascaded MZI filter. In some instances, the cascaded MZI filter 912a may be referred to as a first of a third pair of cascaded MZI filters. In some instances, the cascaded MZI filter 912b may be referred to as a second of a third pair of cascaded MZI filters. The nomenclature Nth cascaded MZI together with the first and second of the Nth pair of cascaded MZI filters may indicate stage doubling is used. The nomenclature Nth cascaded MZI together with the first and second of the Nth pair of cascaded MZI filters may also indicate the each of the Nth cascaded MZI together with the first and second of the Nth pair of cascaded MZI filters includes a same passband for each path.

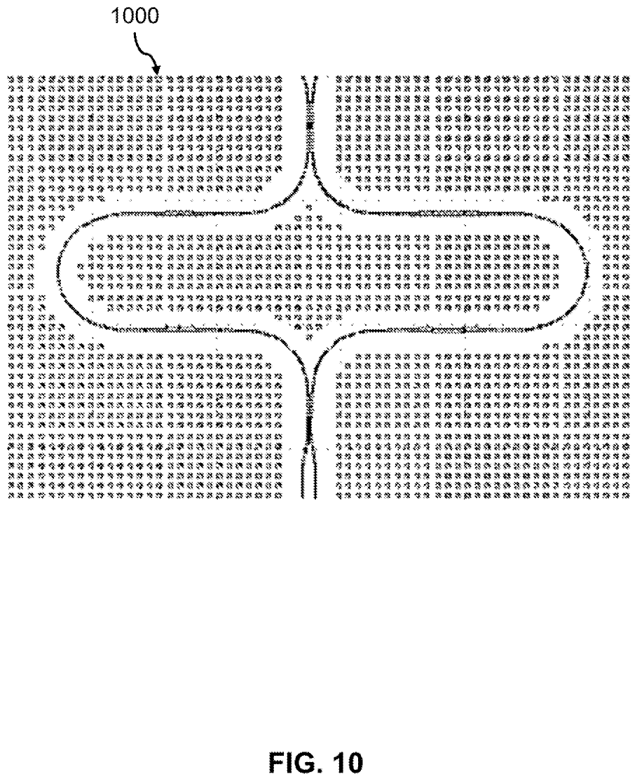

Referring now to FIG. 10, a dummy structure 1000 is described, in accordance with one or more embodiments of the present disclosure. In embodiments, the integrated circuit may include the dummy structure 1000. The dummy structure 1000 may be around the optical waveguide 302 on the substrate. The dummy structure 1000 may also be referred to as a uniform dummy. The term around may refer to forming the dummy structure 1000 on areas of the substrate which are not part of the optical waveguide. The dummy structure 1000 may be formed around the optical waveguide 302 so that the material density across the substrate may be uniform. The material density may refer to a density of silicon nitride film within a given unit square. The substrate may be divided into any number of the unit squares based on the area of the unit square. The dummy structure 1000 may be placed at relatively uniform distances across the substrate to achieve the uniform density. The dummy structure 1000 may be formed of a same material as the optical waveguide 302. For example, the dummy structure 1000 may be formed of a silicon nitride (SiN) film. The dummy silicon nitride may be etched in a pattern that creates a uniform density of the silicon nitride on the substrate. Regions surrounding the waveguide may include islands of silicon nitride material. The islands may be a repeated pattern, such as a pattern of rectangles. The use of the dummy structure 1000 may improve the uniformity of the optical waveguide 302. The dummy structure 1000 may also provide a way to improve or reduce the phase errors. For example, the optical waveguide 302 may route the optical signal 306. In some instances, the uniformity and thickness of the silicon nitride for the waveguide 302 is determined, at least in part, by the dummy material surrounding the optical waveguide 302.

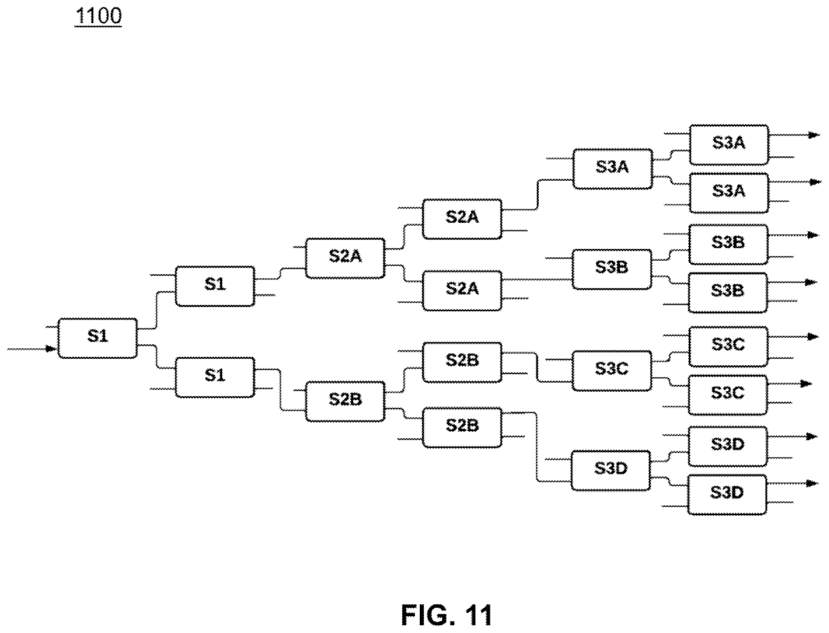

Referring now to FIG. 11, a block diagram of an optical waveguide 1100 configured for wavelength division multiplexing described, in accordance with one or more embodiments of the present disclosure. Although much of the present disclosure has been directed to a two-stage filter for four channels, this is not intended as a limitation of the present disclosure. The number of stages may be increased to increase the channel count. The number of channels for the MZI may be two to the nth power, where n is the number of stages of the MZI. The number of stages may also be decreased to one, such that the number of channels may be two channels. Thus, the MZI may include one or more stages to achieve a desired multiplexing or demultiplexing of two or more channels. In this regard, the MZI may be configured to have any number of channels, such as, but not limited to, two, four, eight, sixteen, thirty-two, and the like. For example, the optical waveguide 1100 may be a three-stage optical waveguide which may include eight channels (see FIG. 11). Notably, increasing to three stages may increasing the footprint. Any of the various techniques described herein may also be utilized for decreasing the footprint of an optical waveguide including N stages. Any number of the stages may also be doubled. For example, FIG. 11 depicts the third stages (S3A), (S3B), (S3C), and (S3D) as being doubled.

Referring generally again to FIGS. 1-11.

Although much of the present disclosure is directed to achieving a desired center wavelength for a cascaded MZI without the use of active tuning, this is not intended as a limitation of the present disclosure. It is contemplated that a cascaded MZI may also include one or more heaters for active tuning of the center wavelength. However, such heaters may not be necessary where the cascaded MZI may be formed of a SiN material or similar film.

It is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented. It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

It is to be understood that depicted architectures are merely exemplary and that many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Additionally, unless otherwise indicated, a description indicating that one component is “connected to” another component or “between” two components indicates that such components are functionally connected and does not necessarily indicate that such components are physically in contact. Rather, such components may be in physical contact or may alternatively include intervening elements. Similarly, descriptions that a particular component is “fabricated over” another component (alternatively “located on,” “disposed on,” or the like) indicates a relative position of such components but does not necessarily indicate that such components are physically in contact. Such components may be in physical contact or may alternatively include intervening elements.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed:

1. A method comprising:
depositing a film on a substrate;
measuring a thickness of the film;
comparing the thickness with a target thickness of the film;
trimming the thickness of the film to within a range of the target thickness based on the comparison of the thickness to the target thickness; and
fabricating an optical waveguide from the film, wherein the optical waveguide is configured as a wavelength division multiplexer (WDM) for an optical signal by one or more cascaded Mach-Zehnder interferometer (MZI) filters, wherein the trimming affects a center wavelength of the WDM.

2. The method of claim 1, wherein the one or more cascaded MZI filters includes a first cascaded MZI filter and a second cascaded MZI filter.

3. The method of claim 2, wherein the optical waveguide is fabricated with a first stage and a second stage; wherein the first stage includes the first cascaded MZI filter; wherein the second stage includes the second cascaded MZI filter.

4. The method of claim 1, wherein the film is formed by a chemical vapor deposition process; wherein the film is a silicon nitride (SiN) film; wherein the substrate is a silicon wafer.

5. The method of claim 1, wherein the thickness of the one or more cascaded MZI filters are trimmed to within the range of the target thickness by an ion beam milling system.

6. The method of claim 1, wherein the range is between 475.2 nanometers and 484.8 nanometers.

7. An integrated circuit comprising:
a substrate; and
an optical waveguide on the substrate, the optical waveguide configured for wavelength division multiplexing (WDM) an optical signal, the optical waveguide comprising:
a first port;
a first stage comprising a first cascaded Mach-Zehnder interferometer (MZI) filter and a first pair of cascaded MZI filters; wherein the first cascaded MZI filter is coupled to the first port; wherein the first pair of cascaded MZI filters are each coupled to the first cascaded MZI filter; wherein the first cascaded MZI filter and the first pair of cascaded MZI filters each comprise one or more passbands; and
a plurality of second ports.

8. The integrated circuit of claim 7, wherein the first cascaded MZI filter and the first pair of cascaded MZI filters each comprise a first arm and a second arm; wherein the first arm and the second arm are phase compensated such that a first index change in the first arm is cancelled with a second index change of the second arm.

9. The integrated circuit of claim 8, wherein the first arm comprises one or more first phase sections; wherein the one or more first phase sections each include a first length and a first width; wherein the second arm comprises one or more second phase sections; wherein the one or more second phase sections each comprise a second length and a second width; wherein the first arm and the second arm are phase compensated based on the first width, the first length, the second width, and the second length; wherein the first width is greater than the second width.

10. The integrated circuit of claim 7, wherein the first cascaded MZI filter and the first pair of cascaded MZI filters each comprise a first arm and a second arm; wherein the first arm and the second arm each comprise one or more directional couplers by which at least one MZI filter is cascaded with at least one additional MZI filter; wherein the directional coupler comprises a U-bend coupler.

11. The integrated circuit of claim 7, wherein the first cascaded MZI filter and the first pair of cascaded MZI filters each comprise a first arm and a second arm; wherein the first arm and the second arm each comprise a nonlinear taper; wherein the nonlinear taper is a convex taper.

12. The integrated circuit of claim 7, wherein the optical waveguide is a two-stage optical waveguide comprising the first stage and a second stage; wherein the plurality of second ports comprises four ports;
wherein the second stage comprises:
a second cascaded MZI filter and a second pair of cascaded MZI filters; wherein the second cascaded MZI filter is coupled to a first of the first pair of cascaded MZI filters; wherein the second pair of cascaded MZI filters are each coupled to the second cascaded MZI filter; wherein a first of the second pair of cascaded MZI filters comprises a first passband of the one or more passbands; wherein a second of the second pair of cascaded MZI filters comprises a second passband of the one or more passbands; and
a third cascaded MZI filter and a third pair of cascaded MZI filters; wherein the third cascaded MZI filter is coupled to a second of the first pair of cascaded MZI filters; wherein the third pair of cascaded MZI filters are each coupled to the third cascaded MZI filter; wherein a first of the third pair of cascaded MZI filters comprises a third passband; wherein a second of the third pair of cascaded MZI filters comprises a fourth passband.

13. The integrated circuit of claim 12, wherein at least one of:
the first of the second pair of cascaded MZI filters is interleaved with the second of the second pair of cascaded MZI filters;
the second of the second pair of cascaded MZI filters is interleaved with the first of the third pair of cascaded MZI filters; or
the first of the third pair of cascaded MZI filters is interleaved with the second of the third pair of cascaded MZI filters.

14. The integrated circuit of claim 13, wherein the first of the second pair of cascaded MZI filters is interleaved with the second of the second pair of cascaded MZI filters by being offset from the second of the second pair of cascaded MZI filters.

15. The integrated circuit of claim 14, wherein the first of the second pair of cascaded MZI filters comprises one or more directional couplers; wherein the second of the second pair of cascaded MZI filters comprises one or more bent sections; wherein the one or more directional couplers are adjacent to the one or more bent sections.

16. The integrated circuit of claim 7, wherein the optical waveguide is formed of a silicon nitride film.

17. The integrated circuit of claim 16, further comprising a dummy structure around the optical waveguide; wherein the dummy structure is formed of the silicon nitride film.

18. The integrated circuit of claim 7, wherein at least one of:
the optical waveguide is configured as a demultiplexer, the first port is an input port, and the plurality of second ports are output ports; or
the optical waveguide is configured as a multiplexer, the first port is an output port, and the plurality of second ports are input ports.

19. An integrated circuit comprising:
a substrate; and
an optical waveguide formed of a silicon nitride film on the substrate, the optical waveguide configured for wavelength division multiplexing (WDM) an optical signal, the optical waveguide comprising:
a first port;
a first stage comprising a first cascaded Mach-Zehnder interferometer (MZI) filter and a first pair of cascaded MZI filters; wherein the first cascaded MZI filter is coupled to the first port; wherein the first pair of cascaded MZI filters are each coupled to the first cascaded MZI filter;
a second stage comprising:
a second cascaded MZI filter and a second pair of cascaded MZI filters; wherein the second cascaded MZI filter is coupled to a first of the first pair of cascaded MZI filters; wherein the second pair of cascaded MZI filters are each coupled to the second cascaded MZI filter; wherein a first of the second pair of cascaded MZI filters comprises a first passband; wherein a second of the second pair of cascaded MZI filters comprises a second passband; and
a third cascaded MZI filter and a third pair of cascaded MZI filters; wherein the third cascaded MZI filter is coupled to a second of the first pair of cascaded MZI filters; wherein the third pair of cascaded MZI filters are each coupled to the third cascaded MZI filter; wherein a first of the third pair of cascaded MZI filters comprises a third passband; wherein a second of the third pair of cascaded MZI filters comprises a fourth passband; and
a plurality of second ports; wherein the plurality of second ports comprises four ports;
wherein the first cascaded MZI filter and the first pair of cascaded MZI filters each comprise fourth-order MZI filters;
wherein the second cascaded MZI filter, the second pair of cascaded MZI filters, the third cascaded MZI filter, and the third pair of cascaded MZI filters each comprise a third-order MZI filters.

20. The integrated circuit of claim 19, wherein the first cascaded MZI filter is interleaved with the first pair of cascaded MZI filters for reducing a footprint of the optical waveguide on the substrate; wherein the first pair of cascaded MZI filters are interleaved by folding and an offset; wherein the first pair of cascaded MZI filters are folded backwards from the first cascaded MZI filter toward the first port; wherein each of the first pair of cascaded MZI filters are offset from the first cascaded MZI filter by a distance.
